(19) United States
(12) Patent Application Publication
(10) Pub. No.: US 2007/0153071 A1
(43) Pub. Date: Jul. 5, 2007

(54) Apparatus and method for ink-jetting and gas-supplying unit

(75) Inventors: Jin-koo Chung, Gyeonggi-do (KR); Dong-won Lee, Gyeonggi-do (KR); Joo-Hyeon Lee, Gyeonggi-do (KR); Jun-ho Choi, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/641,233

(22) Filed: Dec. 18, 2006

(30) Foreign Application Priority Data
Dec. 29, 2005 (KR) 2005-0134257

(51) Int. Cl. B41J 2/17

(52) U.S. Cl. 347/97

(57) ABSTRACT

An inkjet apparatus comprising a jetting unit comprising a stage on which a substrate to be jetted is seated, a nozzle head disposed on the stage; a gas supplying unit comprising an auxiliary gas supply supportively supplying a gas to the jetting unit, and a gas supply selector which selects either a gas supplied from the outside or a gas supplied from the auxiliary gas supply. Thus, the present invention provides an inkjet apparatus which lowers equipment damages due to abnormal gas supply from the outside.

### CROSS-REFERENCE TO RELATED APPLICATIONS

This application claims the benefit of Korean Patent Application No. 2005-0134257, filed on Dec. 29, 2005 in the Korean Intellectual Property Office, the disclosure of which is incorporated herein by reference.

### FIELD OF THE INVENTION

The present invention relates to an ink-jet apparatus and a gas supplying unit which lowers the risk of damage from abnormal gas supply.

### DESCRIPTION OF THE RELATED ART

A flat panel display comprises several organic layers including a color filter layer, an organic semiconductor layer, a light emitting layer and an alignment film which are generally deposited using an inkjet method which requires neither exposure, development or etching processes. Also, the amount of used organic material can be reduced. As substrates have become larger the inkjet apparatus becomes larger and gantry type equipment having a stage and a head main body are designed as an air bearing type which requires gas from the outside. However, when gas supply from the outside is abnormal, a problem arises that the head main body stops operating and a nozzle becomes clogged.

### SUMMARY OF THE INVENTION

The present invention provide an inkjet apparatus which reduces the probability of equipment damage due to abnormal gas supply from the outside and which provides a more reliable gas supplying unit.

In accordance with the invention, a jetting unit comprises a stage for receiving a substrate, a nozzle head disposed on the stage; an auxiliary gas supply unit, and a gas supply selector which selects either an outside gas or a gas supplied from the auxiliary gas supply.

According to another aspect of the present invention, the gas supply selector selects a gas having the higher pressure between the gas from the outside and the gas supplied from the auxiliary gas supply, and supplies the selected gas to the jetting unit.

According to another aspect of the present invention, the inkjet apparatus further comprises a shaft member which is disposed above the stage; and a gas bearing which connects the nozzle head to the shaft member, and wherein the selected gas is supplied to the gas bearing.

According to another aspect of the present invention, the inkjet apparatus further comprises a base on which the stage is stably seated and a level manager which is provided on a lower part of the base and maintains the base horizontally, wherein the selected gas is supplied to the level manager.

According to another aspect of the present invention, the inkjet apparatus further comprises a stage driver which allows the stage to reciprocate on the base.

According to another aspect of the present invention, the shaft member is extended in a direction that is vertical to a direction that the stage moves, and wherein the apparatus further comprises a nozzle head driver which allows the nozzle head to reciprocate in an extension direction of the shaft member.

According to another aspect of the present invention, the level manager is plurally provided, and wherein the apparatus further comprising a level sensor which senses whether the base is horizontal; and a pressure controller which controls the pressure of a gas supplied to the level managers according to the sensing result of the level sensor.

According to another aspect of the present invention, the inkjet apparatus further comprises a pressure sensor which senses the pressure of gas supplied from the outside.

According to another aspect of the present invention, the auxiliary gas supply comprises a gas cylinder.

According to another aspect of the present invention, at least one of the gas supplied from the outside and the gas stored in the auxiliary gas supply comprises air.

The foregoing and/or other aspects of the present invention can be achieved by providing an inkjet method comprising supplying a gas from the outside to a jetting unit; comparing a pressure of the gas supplied from the outside with a pressure of a gas supplied from an auxiliary gas supply; and

selecting one of the gas supplied from the outside and the gas supplied from the auxiliary gas supply to be supplied to the jetting unit.

According to another aspect of the present invention, a gas having a higher pressure between the gas supplied from the outside and the gas supplied from the auxiliary gas supply is supplied to the jetting unit.

According to another aspect of the present invention, the jetting unit further comprises a shaft member and a gas bearing which connects the nozzle head to the shaft member, and wherein the selected gas is supplied to the gas bearing.

According to another aspect of the present invention, the jetting unit further comprises a base on which a stage is seated stably, and a plurality of level managers which is provided on a lower part of the base and maintains the base horizontally, and wherein the selected gas is supplied to the level managers.

According to another aspect of the present invention, the inkjet method further comprises sensing whether the base is horizontal, and adjusting the pressure of the gas supplied to the level managers according to the sensing result of the level managers.

The foregoing and/or other aspects of the present invention can be achieved by providing an inkjet method comprising, supplying a gas supplied from the outside to a jetting unit; comparing a pressure of the gas supplied from the outside with a reference pressure; and supplying a gas supplied from an auxiliary gas supply to the jetting unit when the pressure of the gas supplied from the outside is lower than the reference pressure.

The foregoing and/or other aspects of the present invention can be achieved by providing a gas supplying unit which supplies a gas to a jetting unit, the gas supplying unit comprising a first pipe through which a gas is supplied from the outside; a second pipe through which a gas is supplied from an auxiliary gas supply; and a gas supply selector which is connected with the first and second pipes and supplies a gas having a higher pressure between the gas supplied from the outside and the gas supplied from the auxiliary gas supply, to the jetting unit.

According to another aspect of the present invention, the auxiliary gas supply comprises a gas cylinder.

According to another aspect of the present invention, at least one of the gas supplied from the outside and the gas stored in the auxiliary gas supply comprises air.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a schematic, perspective view of an inkjet apparatus according to a first embodiment of the present invention;

FIGS. 2a and 2b illustrate a nozzle head of the inkjet apparatus according to the first embodiment of the present invention;

FIG. 3 is a schematic view of a gas bearing of the inkjet apparatus according to the first embodiment of the present invention;

FIG. 4 is a control block diagram to explain a gas supply selector of the inkjet apparatus according to the first embodiment of the present invention;

FIG. 5 is a control block diagram of the inkjet apparatus according to the first embodiment of the present invention;

FIG. 6 illustrates a nozzle head path of the inkjet apparatus according to the first embodiment of the present invention;

FIG. 7 illustrates an inkjet method using the inkjet apparatus according to the first embodiment of the present invention;

FIG. 8 is an equivalent circuit of a display apparatus which is manufactured by using the inkjet apparatus according to the first embodiment of the present invention;

FIG. 9 is a sectional view of the display apparatus manufactured by using the inkjet apparatus according to the first embodiment of the present invention;

FIG. 10 is a control block diagram of an inkjet apparatus according to a second embodiment of the present invention; and

FIG. 11 is a flowchart of an inkjet method using the inkjet apparatus according to the second embodiment of the present invention.

### DETAILED DESCRIPTION OF EMBODIMENTS

Hereinafter, embodiments of the present invention will be described with reference to accompanying drawings, wherein like numerals refer to like elements and repetitive descriptions will be avoided as necessary.

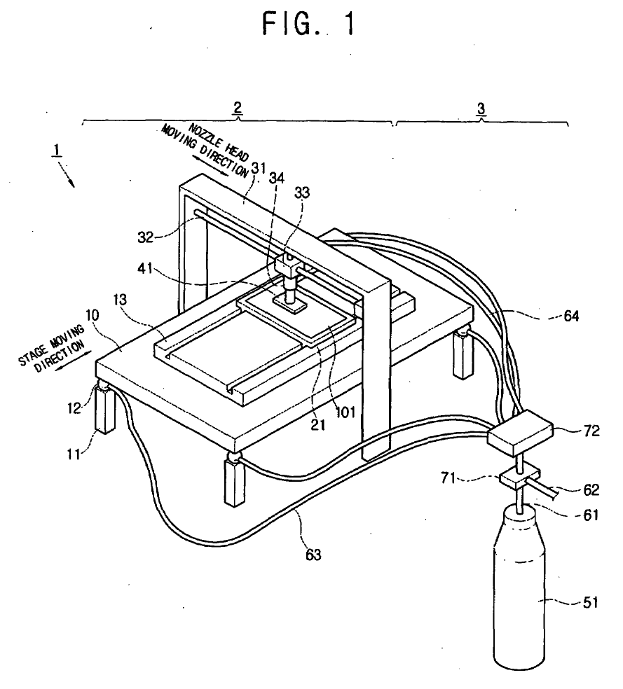

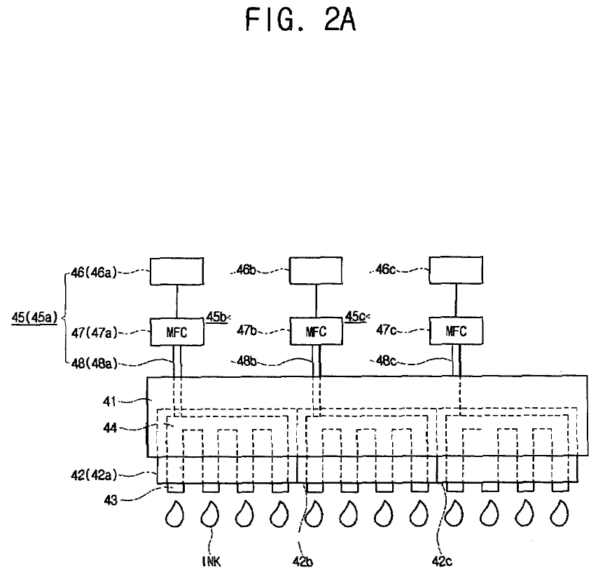

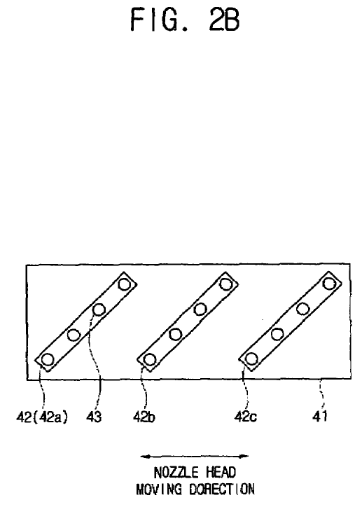

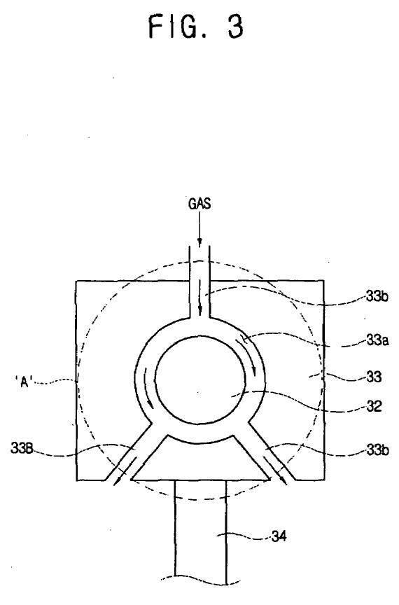

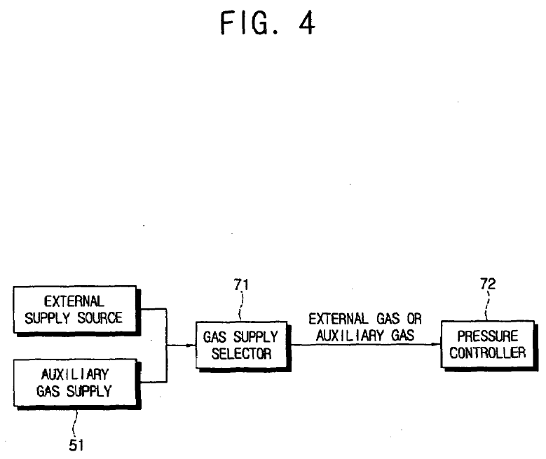

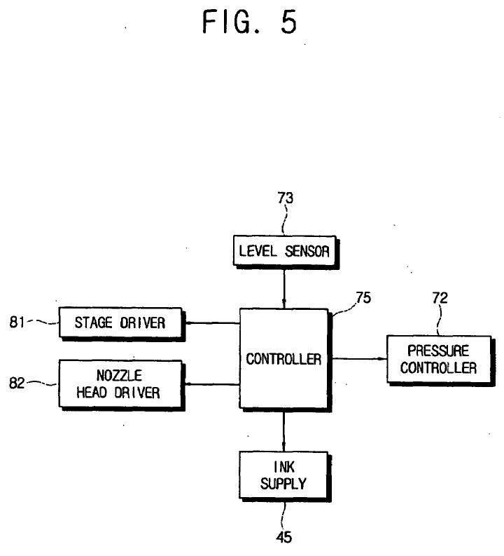

Hereinafter, an inkjet apparatus according to a first embodiment of the present invention will be described with reference to FIGS. 1 through 5. FIG. 1 is a perspective view of the inkjet apparatus according to the first embodiment of the present invention. FIGS. 2a and 2b illustrate a nozzle head of the inkjet apparatus according to the first embodiment of the present invention. FIG. 3 is a schematic view of a gas bearing of the inkjet apparatus according to the first embodiment of the present invention. FIG. 4 is a block diagram to explain a gas supply selector of the inkjet apparatus according to the first embodiment of the present invention. FIG. 5 is a control block diagram of the inkjet apparatus according to the first embodiment of the present invention.

An inkjet apparatus 1 comprises a jetting unit 2; and a gas supplying unit 3 which supplies gas to jetting unit 2. Jetting unit 2 comprises a base 10, a stage 21 and a nozzle head 42. Stage 21 and the nozzle head 42 move in a direction which is perpendicular to each other. Stage 21 is connected with a stage driver 81. The nozzle head 42 is connected with a nozzle head driver 82. The gas supplying unit 3 comprises an auxiliary gas supply 51, gas pipes 61, 62, 63 and 64, a gas supply selector 71 and a pressure controller 72.

Hereinafter, jetting unit 2 will be described first.

Base 10 has a rectangular shape, and is extended to accommodate the moving direction of stage 21. A rail 13 is provided on base 10. Stage 21 can move back and forth along rail 13. Base 10 is made of a heavy material so as not to change position with movement of stage 21. For example, base 10 may be made of stone. Base 10 is supported by four stanchions 11. A level manager 12 is provided between base 10 and the respective stanchions 11.

When stage 21 moves along rail 13, each of stanchions 11 may receive a different load, thereby making it difficult to maintain base 10 horizontal. When base 10 is not horizontal, stage 21 and an substrate 101 are tilted. When ink is jetted onto substrate 101 which is to be ink-jetted, substrate 101 is positioned so as to be closely adjacent to a nozzle 43. If substrate 101 is not horizontal, the interval between substrate 101 and the nozzle 43 becomes non-uniform, thereby causing more ink to be deposited on some locations of substrate 101 and less ink on other locations, thereby lowering the overall quality of ink deposition.

To solve the foregoing problem, pneumatic level manager 12 which is positioned between each of stanchions 11 and base 10 receives gas selected by the gas supply selector 71 to maintain base 10 horizontal. There are provided 4 level managers 12 in an exemplary embodiment of the present invention. Advantageously, a different gas pressure is supplied to each of level managers 12, as will hereinafter be explained.

Stage 21 moves back and forth along rail 13. Substrate 101 which is to be ink-jetted is seated on stage 21 and moves together with stage 21. Stage 21 is moved back and forth by a stage driver 81 (not shown in FIG. 1 but depicted in FIG. 5). Stage 21 may comprise a vacuum chuck (not shown) to hold substrate 101 thereto.

A supporting arbor 31 is provided on stage 21 and supports a head main body 41. The supporting arbor 31 has a [symbol] -shape. A plurality of nozzle heads 42 (shown in FIG. 2A) are mounted in head main body 41. Arbor 31 extends vertically above stage 21's direction of motion.

A shaft member 32 is attached to the side frame of supporting arbor 31, and extends transversely to the direction stage 21's direction of motion. Head main body 41 moves back and forth along shaft member 32 transporting nozzle head driver 82 (not shown in FIG. 1 but shown in FIG. 5).

The head main body 41 is connected with the shaft member 32 through a shaft coupler 33 and an intermediate connector 34.

Referring to FIGS. 2a and 2b, the nozzle heads 42 will be described in detail. FIG. 2b illustrates the head main body 41 mounting the nozzle heads 42 therein, viewed from stage 21.

The head main body 41 (see FIG. 2A) is elongated along the nozzle head moving direction and has a rectangular shape. The nozzle heads 42 comprise three sub nozzle heads 42a, 42b and 42c which are mounted to the head main body 41 along the nozzle head moving direction. Each of the nozzle heads 42 extends to form a predetermined angle with respect to the nozzle head's direction of movement. The angle may be adjusted according to intervals of an ink-jetted object.

Four nozzles 43 are mounted in the respective nozzle heads 42 in a straight line. Nozzle heads 42 receive ink from an ink supply 45 which comprises an ink tank 46 for storing ink; a mass flow controller 47 for controlling ink mass flow; and a pipe 48 which connects ink tank 46 to head main body 41. The ink supply 45 comprises three sub ink supplies 45a, 45b and 45c. The sub ink supplies 45a, 45b and 45c supply ink to the sub nozzle heads 42a, 42b, and 42c, which are connected therewith respectively. The ink tank 46, the mass flow controller 47 and the pipe 48 respectively comprise three sub ink tanks 46a, 46b and 46c, three sub mass flow controllers 47a, 47b and 47c, and three sub pipes 48a, 48b and 48c.

The sub ink supplies 45a, 45b and 45c may supply the same or different ink.

Ink which is supplied to the head main body 41 through the pipe 48 is transmitted to/jetted through the nozzles 43 through a flow path 44 which is provided between the head main body 41 and the nozzle heads 42.

Referring to FIG. 3, the connection of the shaft member 32 and the shaft coupler 33 will be described. A through hole 33a which has a larger diameter than the shaft member 32, is provided in the shaft coupler 33 in an extension direction of the shaft member 32. A plurality of gas through holes 33b is provided in the shaft coupler 33 to connect the shaft through hole 33a and the outside.

When the inkjet apparatus 1 operates, the shaft member 32 floats in the shaft through hole 33a. Gas is introduced to/leaked from a space which surrounds the shaft member 32, thereby preventing the shaft member 32 from directly contacting with the shaft coupler 33. The shaft member 32 and the shaft coupler 33 form a gas bearing “A”. When gas flowing in the shaft through hole 33a comprises air, it is called an air bearing.

Gas is supplied from the gas supplying unit 3 through the gas through hole 33b.

The gas supplying unit 3 will now be described with reference to FIGS. 1 and 4. When the external gas supply becomes abnormal, the auxiliary gas supply 51 supplies gas to jetting unit 2. The auxiliary gas supply 51 comprises a gas cylinder filled with air, as an exemplary embodiment of the present invention. The pressure of the auxiliary gas supply 51 is slightly lower than pressure of the external gas, but enough to drive jetting unit 2.

Referring to FIG. 4, the gas supply selector 71 receives gas (external gas) from the outside through gas pipes 61 and 62, and gas (auxiliary gas) from the auxiliary gas supply 51. The gas supply selector 71 supplies pressure controller 72 with one having a higher pressure of the external gas and the auxiliary gas. The gas supply selector 71 is connected with two gas supply sources. The gas supply selector 71 may comprise a valve which is turned on to be connected with one having higher pressure of the two gas supply sources. Here, the external gas normally has higher pressure than the auxiliary gas to become a main gas supply source.

As the pressure of the auxiliary gas is set lower than that of the external gas, the gas supply selector 71 selects/supplies the external gas, normally. However, when the external gas supply becomes abnormal, the pressure of the external gas is reduced. When the pressure of the external gas is reduced below the pressure of the auxiliary gas, the gas supply selector 71 selects/supplies the auxiliary gas. Even though the pressure of the auxiliary gas is lower than that of the external gas, the auxiliary gas afford to drive jetting unit 2. Thus, the nozzles 43 may be prevented from being clogged when it is an emergency such as an abnormal external gas supply.

Gas selected by the gas supply selector 71 is supplied to jetting unit 2 through pressure controller 72. Specifically, gas which is transmitted through pressure controller 72 is supplied to the level managers 12 and the gas bearing “A” of jetting unit 2.

Pressure controller 72 receives gas from the gas supply selector 71 and supplies the gas to the level managers 12 and the gas bearing “A”.

Pressure controller 72 will be described in detail with reference to FIG. 5.

A controller 75 controls the ink supply 45, the stage driver 81 and the nozzle head driver 82. The controller 75 controls the nozzle heads 42 and substrate 101 to move relatively and jets ink to the ink-jetted substrate.

Meanwhile, the controller 75 is connected with a level sensor 73 which senses the horizontalness of base 10. The level sensor 73 determines whether base 10 is horizontal, and which part is high or low in case that base 10 is not horizontal. The controller 75 controls pressure controller 72 to adjust the pressure of gas supplied to the respective level managers 12 based on the sensing result of the level sensor 73.

Pressure controller 72 supplies gas having relatively high pressure, to level manager 12 corresponding to the lower part of base 10, to make base 10 horizontal.

Alternative arrangements of the first embodiment of the present invention are now apparent. For example, gas may be supplied to gas bearing “A” directly from gas supply selector 71 instead of through pressure controller 72 and an individual pressure controller 72 may be respectively provided for each of level managers 12. Further, level managers 12 and gas bearing “A” may not be the only parts which require gas in jetting unit 2.

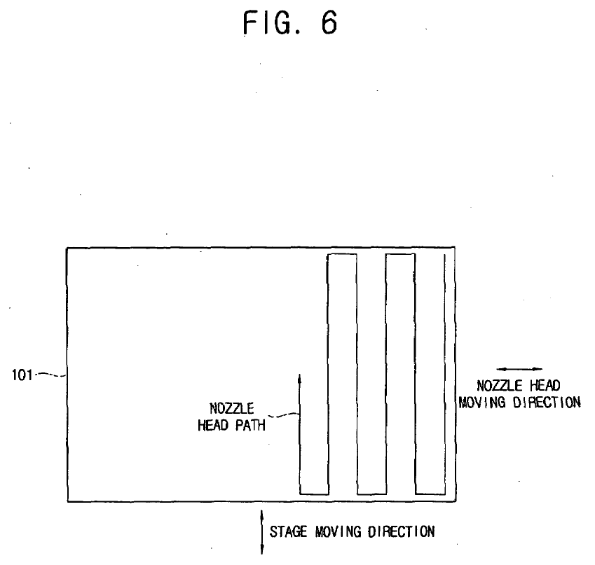

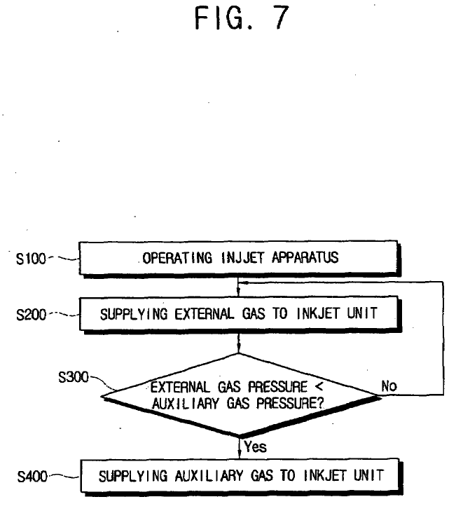

Referring to FIGS. 6 and 7, the operation of the ink apparatus according to the first embodiment of the present invention will be described. FIG. 6 illustrates a nozzle head path of the inkjet apparatus according to the first embodiment of the invention. FIG. 7 is a control flowchart of an inkjet method using the inkjet apparatus according to the first embodiment of the invention.

As shown in FIG. 6, the nozzle heads 42 move in a zigzag pattern with respect to substrate 101 so as to jet ink across substrate 101.

The nozzle heads 42 move from right to left, and stage 21 on which substrate 101 is seated, reciprocates upwards and downwards, to jet ink. While stage 21 moves, the nozzle heads 42 do not move when jetting ink.

As shown in FIG. 7, the inkjet apparatus 1 having jetting unit 2 and gas supplying unit 3 operates to jet ink (S100).

When the inkjet apparatus 1 operates, external gas is supplied from the outside to jetting unit 2 (S200) and ink is jetted as shown in FIG. 6. As long as the external gas has a higher pressure than the auxiliary gas at a normal state, the gas supply selector 71 selects/supplies the external gas. The external gas is supplied to the level managers 12 and the gas bearing “A” to maintain base 10 in a horizontal state and to move the nozzle heads 42.

Gas supply selector 71 compares the pressure between the external gas and the auxiliary gas while ink is jetted (S300) and continuously selects/supplies the external gas when the pressure of the external gas is higher than that of the auxiliary gas.

When the pressure of the external gas is lower than that of the auxiliary gas, gas supply selector 71 selects/supplies the auxiliary gas (S400).

With such a method, jetting unit 2 receives gas with a proper pressure, regardless of the abnormal external gas supply, thereby preventing the nozzles 43 from being clogged.

When the external gas supply is normalized, the gas supply selector 71 selects/supplies the external gas again. Here, the auxiliary gas supply 51 may be replaced or gas is filled again.

When stabilization of the external gas supply is delayed, the ink-jetting operation is stopped and the nozzle heads 42 may be moved using gas supplied by the auxiliary gas supply 51 to a predetermined place where a maintenance operation can be performed. Here, the maintenance operation comprises jetting ink to a spittoon to prevent clogging of the nozzle 43.

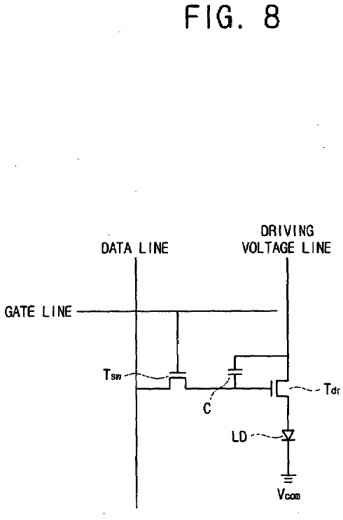

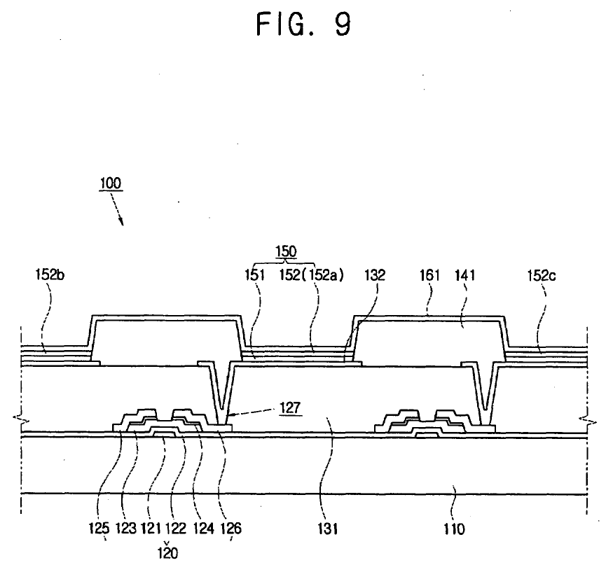

A display apparatus which employs the inkjet apparatus according to the first embodiment of the present invention will be described with reference to FIGS. 8 and 9.

FIG. 8 is an equivalent circuit of the display apparatus which is manufactured by using the inkjet apparatus according to the first embodiment of the present invention. FIG. 9 is a sectional view of the display apparatus manufactured by using the inkjet apparatus according to the first embodiment of the present invention.

As shown in FIG. 8, a single pixel comprises a plurality of signal lines. The signal lines comprise a gate line which transmits a scanning signal; a data line which transmits a data signal; and a driving voltage line which transmits a driving voltage. The data line is adjacent to the driving voltage line and in parallel therewith. The gate line is extended and perpendicular to the data line and the driving voltage line.

Each pixel comprises an organic light emitting device (LD); a switching thin film transistor Tsw; a driving thin film transistor Tdr and a capacitor (C).

The driving thin film transistor Tdr comprises a control terminal, an input terminal and an output terminal. The control terminal thereof is connected with the switching thin film transistor Tsw, the input terminal is connected with the driving voltage line, and the output terminal is connected with the organic light emitting device (LD).

The organic light emitting device (LD) comprises an anode which is connected with the output terminal of the driving thin film transistor Tdr; and a cathode which is connected with a common voltage Vcom. The organic light emitting device (LD) emits light in different levels according to an output current of the driving thin film transistor Tdr, to display an image. The current of the driving thin film transistor Tdr depends on the voltage between the control terminal and the output terminal.

The switching thin film transistor Tsw comprises a control terminal, an input terminal and an output terminal. The control terminal thereof is connected with the gate line, the input terminal is connected with the data line and the output terminal is connected with the control terminal of the driving thin film transistor Tdr. The switching thin film transistor Tsw transmits the data signal supplied to the data line according to the scanning signal supplied to the gate line, to the driving thin film transistor Tdr.

The capacitor (C) is connected between the control terminal and the input terminal of the driving thin film transistor Tdr. The condenser (C) charges and maintains the data signal that is input to the control terminal of the driving thin film transistor Tdr.

As shown in FIG. 9, the display apparatus 100 manufactured according to the present invention comprises a thin film transistor 120 which is formed on an insulating substrate 110; a pixel electrode 132 which is electrically connected with the thin film transistor 120; and an organic layer 150 which is formed on the pixel electrode 132.

FIG. 9 illustrates the thin film transistor 120 which comprises amorphous silicon, but not limited thereto. Alternatively, the thin film transistor 120 may comprise poly silicon.

Hereinafter, the display apparatus 100 manufactured according to the present invention will be described in detail.

A gate electrode 121 is formed on the insulating substrate 110 which is made of an insulating material such as glass, quartz, ceramic or plastic.

A gate insulating film 122 which is made of silicon nitride (SiNx) is formed on the insulating substrate 110 and the gate electrode 121. A semiconductor layer 123 comprising amorphous hydrogenated silicon and an ohmic contact layer 124 comprising n+ amorphous silicon hydride highly doped with an n-type dopant are sequentially formed on the gate insulating film 122 corresponding to the gate electrode 121. Here, the ohmic contact layer 124 is separated into two parts with respect to the gate electrode 121.

A source electrode 125 and a drain electrode 126 are formed on the ohmic contact layer 124 and the gate insulating film 122. Further, the source electrode 125 and the drain electrode 126 are separated with respect to the gate electrode 121.

A passivation film 131 is formed on the source electrode 125, the drain electrode 126 and the semiconductor layer 123 exposed between the source and drain electrodes 125 and 126. The passivation film 131 may be made of silicon nitride (SiNₓ) and/or an organic material. A contact hole 127 is formed on the passivation film 131 to expose the drain electrode 126.

The pixel electrode 132 is formed on the passivation film 131. The pixel electrode 132 is referred to as an anode, and supplies a hole to an organic light emitting layer 152. The pixel electrode 132 comprises a transparent conductive material such as indium tin oxide (ITO), indium zinc oxide (IZO) and formed by a sputtering method. The pixel electrode 132 may be patterned as a rectangle, seen from a plate surface.

A partition wall 141 is formed between the pixel electrodes 132. The partition wall 141 divides the pixel electrodes 132 and defines a pixel region. The partition wall 141 is formed on the thin film transistor 120 and the contact hole 127. The partition wall 141 prevents the source electrode 125 and the drain electrode 126 of the thin film transistor 120 from being short-circuited with the common electrode 161. The partition wall 141 may be made of a photosensitive material such as acrylic resin, or polyimide resin which has heat resistance and solvent resistance; or an inorganic material such as SiO₂, and TiO₂. Further, the partition wall 141 may comprise a double structure having an organic layer and an inorganic layer.

A hole injecting layer 151 and the organic light emitting layer 152 are formed on the pixel electrode 132.

The hole injecting layer 151 may comprise poly(3,4-ethylenedioxy thiophene)(PEDOT) and polystyrene sulfonic acid (PSS).

The organic light emitting layer 152 comprises a red light emitting layer 152a which emits red light; a green light emitting layer 152b which emits green light; and a blue light emitting layer 152c which emits blue light.

The organic light emitting layer 152 comprises a poly fluorene derivative; a (poly)paraphenylenevinylene derivative; a polyphenylene derivative; polyvinylcarbazole; and poly thiophene. Further, these polymer materials can be used by being doped with a perylene pigment; a rothermine pigment; rubrene; perylene; 9,10-diphenylanthracene; tetraphenylbutadiene; Nail red; coumarine 6; Quinacridone, etc.

The hole transmitted from the pixel electrode 132 is combined with an electron supplied from a common electrode 161 in the organic light emitting layer 152, thereby creating an exciton and emitting light during a deactivation process of the exciton.

The common electrode 161 is provided on the partition wall 141 and the organic light emitting layer 152. The common electrode 161 is called a cathode and supplies an electron to the organic light emitting layer 152. The common electrode 161 may be stacked with a calcium layer and an aluminum layer. Preferably, the calcium layer which has a low work function is disposed adjacent to the organic light emitting layer 152.

Lithium fluoride increases light emitting efficiency according to material of the organic light emitting layer 152, and thus a lithium fluoride layer may be formed between the organic light emitting layer 152 and the common electrode 161. When the common electrode 161 is made of an opaque material such as aluminum or silver, light emitted from the organic light emitting layer 152 is transmitted to the insulating substrate 110 which is called a bottom emission type.

The display apparatus 100 may further comprise an electron transfer layer (not shown) and an electron injection layer (not shown) which are disposed between the organic light emitting layer 152 and the common electrode 161. The display apparatus 100 may further comprise an encapsulation member which prevents moisture and air from being introduced to the organic layer 150 and/or another passivation film to protect the common electrode 161. The encapsulation member may comprise sealing resin and a sealing can.

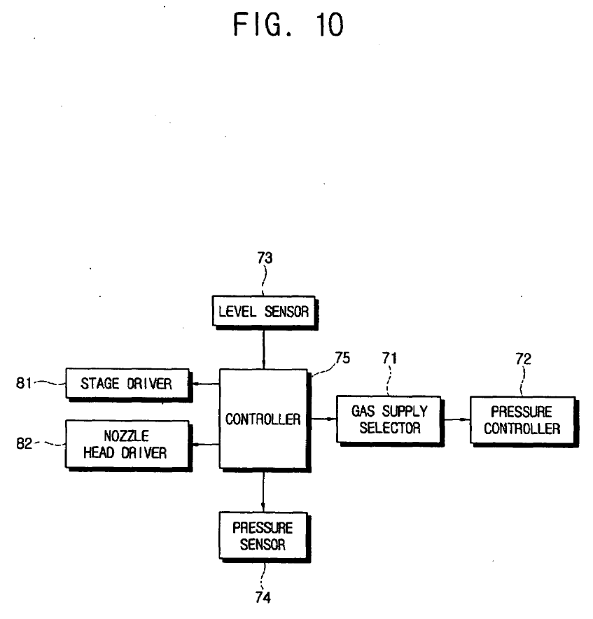

Hereinafter, an inkjet apparatus according to a second embodiment of the present invention will be described with reference to FIG. 10. FIG. 10 is a control block diagram of the inkjet apparatus according to the second embodiment of the present invention.

The inkjet apparatus according to the second embodiment of the present invention further comprises a pressure sensor 74 which senses the pressure of the external gas and a controller 75 that controls gas supply selector 71 based on the sensing result provided by pressure sensor 74.

Controller 75 has a reference pressure and controls the gas supply selector 71 to select auxiliary gas when the pressure of the external gas is lower than the reference pressure. The reference pressure, e.g., may be set to be lower than the normal pressure of the external gas, and set to be higher than the pressure of auxiliary gas.

Alternatively, pressure sensor 74 may additionally sense the gas pressure of the auxiliary gas supply 51 and the controller 75 may determine whether the pressure of the auxiliary gas maintains proper value.

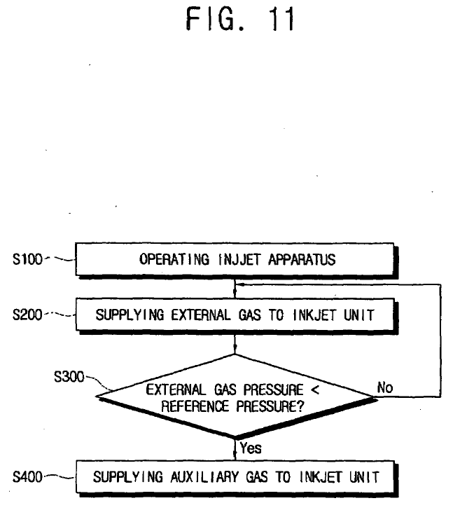

FIG. 11 is a control flowchart of an inkjet method using the inkjet apparatus according to the second embodiment of the present invention.

As shown therein, the inkjet apparatus 1 comprising a jetting unit 2 and a gas supplying unit 3 operates to jet ink (S101).

When the inkjet apparatus 1 operates, external gas is supplied from the outside to jetting unit 2 (S201), and ink is jetted as shown in FIG. 6. So long as the external gas has a higher pressure than the auxiliary gas supply 51 at a normal state, gas supply selector 71 selects/supplies the external gas. The external gas is supplied to level managers 12 and to gas bearing “A” to maintain base 10 in the horizontal state and to move nozzle heads 42.

While ink is jetted, pressure sensor 74 senses the pressure of the external gas and controller 75 compares the pressure of the external gas and the reference pressure (S301).

When the pressure of the external gas is higher than that of the auxiliary gas, the controller 75 controls the gas supply selector 71 to continuously select/supply the external gas.

When the external gas supply becomes abnormal, e.g., the pressure of the external gas is lowered. When the pressure of the external gas is lower than the reference pressure, controller 75 controls gas supply selector 71 to select/supply the auxiliary gas (S401).

With such a method, jetting unit 2 receives gas with a proper pressure, regardless of the abnormal external gas supply, thereby preventing nozzles 43 from being clogged.

When the external gas supply becomes stable and the pressure of the external gas is higher than the reference pressure, controller 75 controls the gas supply selector 71 to select/supply the external gas again. Here, an auxiliary gas supply 51 may be replaced and gas is filled again.

When stabilization of the external gas supply is delayed, the ink-jetting operating is stopped and nozzle heads 42 may be moved using gas supplied by the auxiliary gas supply 51 to a predetermined place where a maintenance operation can be performed.

The inkjet apparatus and the inkjet method according to the present invention can be applicable to manufacture a substrate other display apparatus, other than the OLED.

For example, the present invention can be applicable to manufacture an organic thin film transistor substrate which uses an organic semiconductor as a semiconductor layer. The organic thin film transistor can be used in an organic light emitting diode (OLED) or a liquid crystal display (LCD).

The apparatus and the method for ink-jetting according to the present invention can be applicable to manufacture a color filter substrate, particularly in forming an alignment film using polyamide or in manufacturing a color filter layer.

As described above, the present invention provides an apparatus and a method for ink-jetting which reduces equipment damages due to abnormal external gas supply.

Further, the present invention provides a gas supplying unit which reduces the equipment damages due to the abnormal external gas supply.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An inkjet apparatus comprising:
a jetting unit comprising a stage on which a substrate to be jetted is seated,
a nozzle head disposed on the stage; and
a gas supplying unit comprising an auxiliary gas supply supportively supplying a gas to the jetting unit, and a gas supply selector which selects one of a gas supplied from outside and a gas supplied from the auxiliary gas supply.

2. The inkjet apparatus according to claim 1, wherein the gas supplied from the outside is a main gas supply.

3. The inkjet apparatus according to claim 2, wherein the gas supply selector selects a gas having a higher pressure between the gas from the outside and the gas supplied from the auxiliary gas supply, and supplies the selected gas to the jetting unit.

4. The inkjet apparatus according to claim 2, the apparatus further comprising:
a shaft member which is disposed above the stage; and
a gas bearing which connects the nozzle head to the shaft member, and wherein
the selected gas is supplied to the gas bearing.

5. The inkjet apparatus according to claim 1, further comprising:
a base on which the stage is stably seated; and
a level manager which is provided on a lower part of the base and maintains the base horizontally,
wherein the selected gas is supplied to the level manager.

6. The inkjet apparatus according to claim 5, further comprising a stage driver which allows the stage to reciprocate on the base.

7. The inkjet apparatus according to claim 6, wherein the shaft member is extended in a direction that is vertical to a direction that the stage moves, and wherein the apparatus further comprises a nozzle head driver which allows the nozzle head to reciprocate in an extension direction of the shaft member.

8. The inkjet apparatus according to claim 5, wherein the level manager is plurally provided, and wherein the apparatus further comprises
a level sensor which senses whether the base is horizontal; and
a pressure controller which controls the pressure of a gas supplied to the level managers according to the sensing result of the level sensor.

9. The inkjet apparatus according to claim 1, further comprising a pressure sensor which senses the pressure of gas supplied from the outside.

10. The inkjet apparatus according to claim 1, wherein the auxiliary gas supply comprises a gas cylinder.

11. The inkjet apparatus according to claim 10, wherein at least one of the gas supplied from the outside and the gas stored in the auxiliary gas supply comprises air.

12. An inkjet method comprising:
supplying a gas from outside to a jetting unit;
comparing a pressure of the gas supplied from the outside with a pressure of a gas supplied from an auxiliary gas supply; and
selecting one of the gas supplied from the outside and the gas supplied from the auxiliary gas supply to be supplied to the jetting unit.

13. The inkjet method according to claim 12, wherein a gas having a higher pressure between the gas supplied from the outside and the gas supplied from the auxiliary gas supply is supplied to the jetting unit.

14. The inkjet method according to claim 12, wherein the jetting unit further comprises a shaft member and a gas bearing which connects the nozzle head to the shaft member, and wherein the selected gas is supplied to the gas bearing.

15. The inkjet method according to claim 12, wherein the jetting unit further comprises a base on which a stage is seated stably, and a plurality of level managers which is provided on a lower part of the base and maintains the base horizontally, and wherein the selected gas is supplied to the level managers.

16. The inkjet method according to claim 15, further comprising:
sensing whether the base is horizontal; and
adjusting the pressure of the gas supplied to the level managers according to the sensing result of the level managers.

17. An inkjet method comprising,
supplying a gas from outside to a jetting unit;
comparing a pressure of the gas supplied from the outside with a reference pressure; and
supplying a gas supplied from an auxiliary gas supply to the jetting unit when the pressure of the gas supplied from the outside is lower than the reference pressure.

18. A gas supplying unit which supplies a gas to a jetting unit, the gas supplying unit comprising:
a first pipe through which a gas is supplied from the outside;
a second pipe through which a gas is supplied from an auxiliary gas supply; and
a gas supply selector which is connected with the first and second pipes and supplies a gas having a higher pressure between the gas supplied from the outside and the gas supplied from the auxiliary gas supply, to the jetting unit.

19. The gas supplying unit according to claim 18, wherein the auxiliary gas supply comprises a gas cylinder.

20. The gas supplying unit according to claim 18, wherein at least one of the gas supplied from the outside and the gas stored in the auxiliary gas supply comprises air.
